(19) United States
(12) Patent Application Publication
(10) Pub. No.: US 2026/0301705 A1
(43) Pub. Date: Oct. 1, 2026

(54) DISPLAY DEVICE

(71) Applicant: Sharp Kabushiki Kaisha, Sakai City (JP)

(72) Inventor: Haruhito YABUKI, Sakai City (JP)

(21) Appl. No.: 19/577,868

(22) Filed: Mar. 25, 2026

(30) Foreign Application Priority Data
Mar. 28, 2025 (JP) 2025-056290

(51) Int. Cl. G09G 3/36; G09G 3/20

(52) U.S. Cl. CPC G09G 3/3677; G09G 3/2007; G09G 3/3648; G09G 2300/0408; G09G 2310/0286; G09G 2310/06; G09G 2330/04

(57) ABSTRACT

A control circuit included in a display device is configured to supply a scanning signal line driving circuit with k-phase gate clock signals (k is an integer of 4 or greater) and gate start pulse signals. The scanning signal line driving circuit includes a shift register circuit including a plurality of unit circuits. Each of the gate clock signals respectively input to the unit circuits has voltages of three levels of “L”, “Mid” and “H” (“L”<“Mid”<“H”), and rises in the order of “L” to “Mid” to “H”. Each of the gate start pulse signals respectively input to the unit circuits has voltages of three levels of “L”, “Mid” and “H”, and rises in the order of “L” to “Mid” to “H”. The timing at which the gate clock signals rise from “L” to “Mid” is between the timing at which the gate start pulse signals rise from “L” to “Mid” and the timing at which the gate start pulse signals rise from “Mid” to “H”.

### BACKGROUND

This application claims the benefit of priority to Japanese Patent Application Number 2025-056290 filed on Mar. 28, 2025, the entire contents of which are hereby incorporated by reference.

### 1. TECHNICAL FIELD

The present invention relates to an active matrix-type display device, and specifically, to a display device including a scanning signal line driving circuit, supplying a scanning signal selecting a pixel row, provided integrally with an active matrix substrate of a display panel; for example, a liquid crystal display device including a gate driving circuit provided integrally with an active matrix substrate of a liquid crystal panel (so-called Gate-on-Array (GOA)-type liquid crystal display device).

### 2. DESCRIPTION OF THE RELATED ART

Recently, display devices have been progressively increased in the size, the level of definition and the driving rate. Therefore, it has become difficult to charge pixels to a desired voltage. For example, International Publication WO2009/104306 discloses a liquid crystal display device capable of decreasing the ON-duty time to about half of that of a conventional thin film transistor (hereinafter, referred to as a “TFT”) in order to solve the problem that in the case where the ON-duty time of the TFT is long (e.g., about 50%), the threshold value of the TFT is shifted. For example, International Publication WO2011/074316 discloses a gate driver capable of allowing the gate-ON pulse of a gate scanning signal to fall immediately after the charge time for each of pixel rows is finished. The entirety of the disclosures of International Publication WO2009/104306 and International Publication WO2011/074316 is incorporated herein by reference.
Patent Document No. 1: International Publication WO2009/104306
Patent Document No. 2: International Publication WO2011/074316

### SUMMARY

However, there is a case where even if the gate driver described in International Publication WO2009/104306 is used, for example, the voltage of a gate-ON pulse of a gate scanning signal does not reach a target level when a large-scale, high-definition liquid crystal display device is driven at a high rate, for example, at 240 Hz as described below with reference to the drawings.

In this specification, the following terms will be used. A period in which one complete image is displayed in a display area is referred to as a “frame”, which may also be referred to as a “vertical scanning period”. The reciprocal of the vertical scanning period is referred to as a “vertical frequency”. In the case where, for example, the driving rate is 240 Hz, 240 images are displayed during one second, which may also be represented as “240 fps (240 frames/sec.)”. Each of the frames has a beginning and an end, and does not simply represent a length of time. The final timing of one frame is the same as the first timing of the next frame. A length of time of a frame may be referred to as “1 frame period” or “1 vertical scanning period (1V)”. A period from when the selection of an optional pixel row (scanning line) is started in one frame until the selection of the pixel row (scanning line) is started in the next frame corresponds to 1 frame period (1 vertical scanning period). One frame period includes an effective scanning period (E), which is a period from when the selection (write) of the first pixel row is started (rise of a selection pulse) until the selection (write) of the final pixel row is finished (fall of the selection pulse), and a non-effective scanning period (NE) referred to as a “blanking period”. In one frame, a period from when the selection of one pixel row is started until the selection of the next pixel row is started is referred to as “1 horizontal scanning period (1H total, may simply be referred to as “1H”).

In general, vertical scanning period (V)=effective scanning period (E)+non-effective scanning period (NE), and effective scanning period (E)=horizontal scanning period (H)×number of pixel rows (m). Non-effective scanning period (NE)=vertical scanning period (V)−effective scanning period (E)=vertical scanning period (V)−horizontal scanning period (H)×number of pixel rows (m).

The present invention has an object of suppressing the occurrence of the problem that the voltage of a gate-ON pulse of a gate scanning signal does not reach a target level in the case where, for example, a large-size, high-definition display device is driven at a high rate, for example, at 240 Hz.

The following items illustrate example combinations of technical features that may constitute certain embodiments of the invention. These items are provided for illustrative purposes only and are not intended to limit the invention to any specific configuration. The technical features described in each item may be combined with the features described in other items in any suitable manner, and one or more features described in any item may be selectively adopted without requiring adoption of all features of that item.

### [Item 1]

A display device, comprising:
a plurality of pixels arrayed in a matrix including a plurality of pixel rows and a plurality of pixel columns;
a plurality of scanning signal lines each associated with any of the plurality of pixel rows;
a plurality of display signal lines each associated with any of the plurality of pixel columns;
a scanning signal line driving circuit supplying the plurality of scanning signal lines with scanning signals each including a selection pulse selecting any of the plurality of pixel rows;
a display signal line driving circuit supplying the plurality of display signal lines with display signals; and
a control circuit supplying the scanning signal line driving circuit and the display signal line driving circuit with control signals,
wherein the control circuit is configured to supply the scanning signal line driving circuit with k-phase gate clock signals (k is an integer of 4 or greater) having different phases from each other and gate start pulse signals,
wherein the scanning signal line driving circuit includes a shift register circuit including a plurality of unit circuits,
wherein each of the gate clock signals respectively input to the plurality of unit circuits has voltages of three levels of “L”, “Mid” and “H” (“L”<“Mid”<“H”), and rises in the order of “L” to “Mid” to “H”,
wherein each of the gate start pulse signals respectively input to the plurality of unit circuits has voltages of three levels of “L”, “Mid” and “H” (“L”<“Mid”<“H”), and rises in the order of “L” to “Mid” to “H”, and
wherein the timing at which the gate clock signals rise from “L” to “Mid” is between the timing at which the gate start pulse signals rise from “L” to “Mid” and the timing at which the gate start pulse signals rise from “Mid” to “H”.

### [Item 2]

The display device of claim 1, wherein a period of “Mid” in one cycle of each of the gate clock signals is ¼ of one cycle of each of the gate clock signals or longer.

### [Item 3]

The display device of claim 2, wherein a period of “Mid” in one cycle of each of the gate start pulse signals is ¼ of one cycle of each of the gate clock signals or longer.

### [Item 4]

The display device of claim 1 or 2, wherein a period of “H” in one cycle of each of the gate clock signals is ½ of one cycle of each of the gate clock signals or shorter.

### [Item 5]

The display device of claim 3, wherein a period of “H” in one cycle of each of the gate start pulse signals is ½ of one cycle of each of the gate clock signals or shorter.

An embodiment of the present invention suppresses the occurrence of the problem that the voltage of a gate-ON pulse of a gate scanning signal does not reach a target level in the case where, for example, a large-size, high-definition display device is driven at a high rate, for example, at 240 Hz.

### BRIEF DESCRIPTION OF THE DRAWINGS

FIG. 1 is a schematic view of a liquid crystal display device 100 according to an embodiment of the present invention.

FIG. 2 is a block diagram showing a configuration of a control circuit 150 included in the liquid crystal display device 100.

FIG. 3A is a schematic view illustrating a problem of a conventional liquid crystal display device, and is a schematic view showing waveforms of a gate clock signal GCK and an output Gout of a gate driving circuit.

FIG. 3B is a schematic view illustrating a problem of a liquid crystal display device in a comparative example, and is a schematic view showing waveforms of a gate clock signal GCK and an output Gout of a gate driving circuit.

FIG. 4 is a schematic view showing waveforms of a gate clock signal GCK and an output Gout of a gate driving circuit 120 in the liquid crystal display device 100 according to an embodiment of the present invention.

FIG. 5 is a circuit diagram showing an example of configuration of a bistable circuit (flip-flop) included in a shift register of the gate driving circuit 120.

FIG. 6 is a block diagram of the shift register included in the gate driving circuit 120 in the liquid crystal display device 100 according to embodiment 1 of the present invention.

FIG. 7 is a block diagram of the shift register included in the gate driving circuit 120 in the liquid crystal display device 100 according to embodiment 1 of the present invention, and shows an uppermost zone of a display area.

FIG. 8 is a timing diagram of signals of the liquid crystal display device 100 according to embodiment 1 of the present invention.

FIG. 9 is a timing diagram of signals of the liquid crystal display device 100 according to embodiment 1 of the present invention, and shows waveforms in the shift register.

FIG. 10 is a block diagram of the shift register included in the gate driving circuit 120 in the liquid crystal display device 100 according to embodiment 2 of the present invention.

FIG. 11 is a block diagram of the shift register included in the gate driving circuit 120 in the liquid crystal display device 100 according to embodiment 2 of the present invention, and shows an uppermost zone of the display area.

FIG. 12 is a timing diagram of signals of the liquid crystal display device 100 according to embodiment 2 of the present invention.

FIG. 13 is a timing diagram of signals of the liquid crystal display device 100 according to embodiment 2 of the present invention, and shows waveforms in the shift register.

### DETAILED DESCRIPTION

Hereinafter, an active matrix-type liquid crystal display device including a liquid crystal layer as a display medium layer will be described with reference to the drawings. The display device according to an embodiment of the present invention is not limited to the one described below.

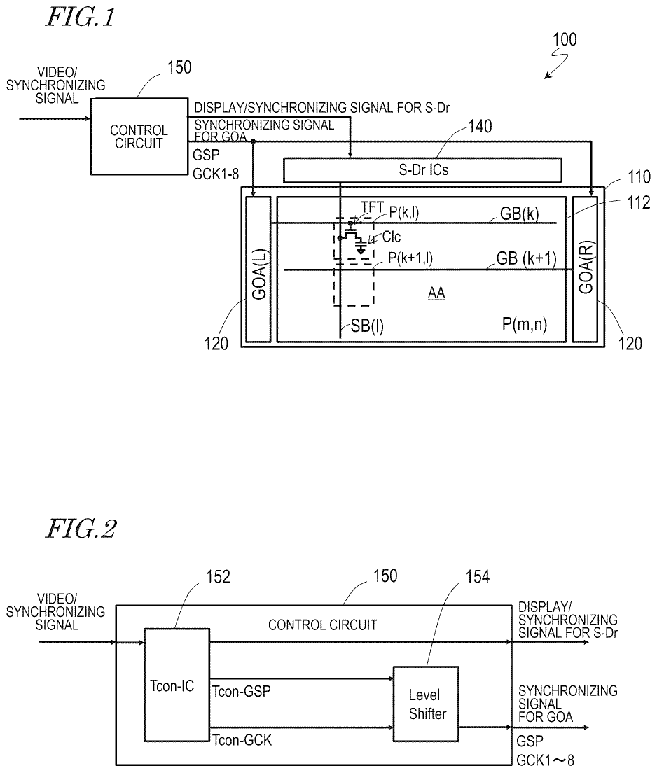

FIG. 1 is a schematic view of a liquid crystal display device 100 according to an embodiment of the present invention.

The liquid crystal display device 100 includes a plurality of pixels P arrayed in a matrix including a plurality of pixel rows (m rows) and a plurality of pixel columns (n columns). The liquid crystal display device 100 is an active matrix-type liquid crystal display device, and includes a thin film transistor (TFT) and a liquid crystal capacitance Clc in each of the pixels P. Each of the pixels P may further include a storage capacitance Cs (not shown) electrically connected in parallel with the liquid crystal capacitance Clc. Herein, the description of the storage capacitance Cs will be omitted for the sake of simplicity. The liquid crystal capacitance Clc is formed of, for example, a pixel electrode (not shown) formed in an active matrix substrate 110 and a common electrode (also referred to as a “counter electrode”; not shown) located to face the pixel electrode with a liquid crystal layer (not shown) being sandwiched therebetween. The common electrode is formed in, for example, a counter substrate 112 located to face the active matrix substrate 110.

An area where the plurality of pixels P are formed is referred to as an “active area AA” or a “display area”. Among the pixels P arrayed in the matrix of m rows and n columns, a pixel P located at row k and column l may be represented as P(k, l). k, l, m and n are positive integers that fulfill the relationship of 1≤k≤m and 1≤l≤n. For example, in a so-called 2K or 4K resolution liquid crystal display device, m=2160 and n=3840×3 (in the case where a color display pixel is formed of an R pixel, a G pixel and a B pixel, the “pixel” mentioned above may be referred to as a “dot”, and a “color display pixel” formed of the three “dots” may be referred to as a “pixel”). Each of the plurality of pixels includes a liquid crystal capacitance Clc including a pixel electrode and a TFT including a drain electrode connected with the pixel electrode.

The liquid crystal display device 100 further includes a plurality of gate bus lines GB (m lines) each associated with any of the plurality of pixel rows and a plurality of source bus lines SB (n lines) each associated with any of the plurality of pixel columns. A gate electrode included in the TFT of each pixel is connected with the gate bus line GB associated with the pixel row including the each pixel. A source electrode included in the TFT of each pixel is connected with the source bus line SB associated with the pixel column including the each pixel.

The liquid crystal display device 100 further includes a gate driving circuit 120 supplying the plurality of gate bus lines GB with gate scanning signals each including a gate-ON pulse GOP turning on the TFT, and also includes a source driving circuit 140 supplying the plurality of source bus lines SB with source signals. In the example shown herein, two gate driving circuits (GOA (L), (R)) 120 are respectively located on both of the left side and the right side of the active area AA. Needless to say, one gate driving circuit 120 located on the left side or on the right of the active area AA may supply all the gate bus lines with gate scanning signals. The gate driving circuit 120 may be represented as “GOA”.

The liquid crystal display device 100 is of a GOA type, and the gate driving circuit 120 is formed in the active matrix substrate 110 like pixel electrodes, the TFTs, the plurality of source bus lines SB and the plurality of gate bus lines GB. As well known, the active matrix substrate 110 includes, for example, a glass plate and also a conductive layer (metal layer), a semiconductor layer and an insulating layer formed on the glass plate, and is produced by a known method. The source driving circuit 140 may be mounted on the active matrix substrate 110 in the form of, for example, source driving ICs (S-DrlCs), or may be a flexible substrate having source driving ICs mounted thereon and connected with the active matrix substrate 120.

The gate driving circuit 120 and the source driving circuit 140 are controlled by a control circuit 150. The control circuit 150 includes a timing controller (Tcon-IC) and a level shifter. The timing controller determines a reference vertical scanning period (VB) and a reference horizontal scanning period (HB) based on an (input) synchronizing signal that is input thereto together with an input video signal or included in the input video signal, in accordance with the resolution of the display device, the driving frequency or the like. The control circuit 150 supplies the gate driving circuit 120 and the source driving circuit 140 with necessary control signals. The liquid crystal display device 100 further includes a power supply circuit (not shown) supplying the gate driving circuit 120 and the source driving circuit 140 with necessary supply voltages.

The controller 150 outputs, to the gate driving circuit 120, a synchronizing signal (horizontal synchronizing signal), a gate start pulse signal GSP including a gate start pulse GSP (the gate start pulse signal is represented by “GSP” like the gate start pulse), and gate clock signals GCK. The gate clock signals GCK are, for example, 8-phase gate clock signals GCK1 through 8. The control circuit 150 also outputs, to the source driving circuit 140, a synchronizing signal (vertical synchronizing signal) and a display signal.

The gate driving circuit 120 supplies the plurality of gate bus lines GB with gate scanning signals such that gate-ON pulses GOP turning on the TFTs are sequentially applied to the plurality of gate bus lines GB in a scanning direction. The source driving circuit 140 supplies the plurality of source bus lines SB with display signals such that the pixel electrodes connected with the TFTs turned on by the gate-ON pulses GOP each have a gray scale voltage applied thereto, the gray scale voltage representing a gray scale to be displayed by the corresponding pixel.

Now, with reference to FIG. 2, a configuration of the control circuit 150 of the liquid crystal display device 100 will be described. FIG. 2 is a block diagram showing the configuration of the control circuit 150.

FIG. 2 will be referred to. In the control circuit 150, a Tcon-IC 152 receives a video signal and an (input) synchronizing signal, generates a Tcon-GSP signal (gate start pulse signal to be output by the Tcon-IC 152) and a Tcon-GCK signal (gate clock signal to be output by the Tcon-IC 152), outputs the Tcon-GSP signal and the Tcon-GCK signal to a level shifter 154, and outputs a display signal and a synchronizing signal to the source driving circuit 140. The Tcon-GSP signal and the Tcon-GCK signal are digital signals, and respectively have voltages of, for example, 0 V and 3.3 V. The level shifter 154 generates a gate start pulse signal GSP and 8-phase gate clock signals GCK1 through 8 based on the Tcon-GSP signal and the Tcon-GCK signal input thereto, and outputs the gate start pulse signal GSP and the 8-phase gate clock signals GCK1 through 8 to the gate driving circuit 120. These signals are analog signals, and respectively have voltages of, for example, −7 V and 35 V.

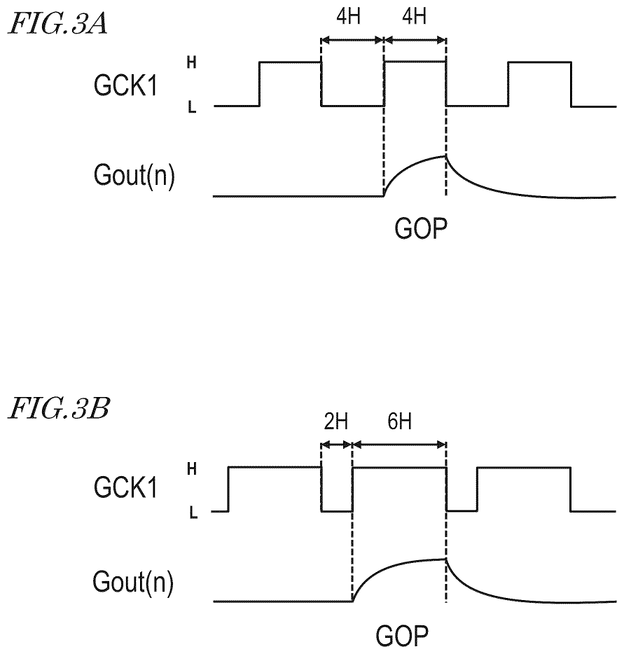

In the case where the gate driving circuit 120 is driven by the eight (8-phase) gate clock signals GCK1 through 8 having different phases from each other, as shown in FIG. 3A, each of the gate clock signals GCK1 through 8 generally has a duty ratio “L”:“H”=4H:4H (H: horizontal scanning period). In this case, as shown in FIG. 3A, the gate-ON pulse GOP included in the gate scanning signal output by the gate driving circuit 120 does not rise sufficiently and the voltage thereof may occasionally not reach a target level.

Thus, as shown in FIG. 3B, each of the gate clock signals GCK1 through 8 may have a duty ratio of “L”:“H”=2H:6H so that the period of H is long. In this case, the voltage of the gate-ON pulse GOP reaches the target level with no need to increase the number of the gate clock signals GCK. However, in this case, the period of “H” is long, and therefore, the problem described in International Publication WO2009/104306 that a characteristic of the TFT is shifted may undesirably become conspicuous in a part of TFTs in the gate driving circuit 120.

Under such circumstances, in the liquid crystal display device 100 according to an embodiment of the present invention, the shift of the TFT characteristic is suppressed as follows. The gate clock signals GCK each have a ternary waveform of “L”, “Mid” and “H” (“L”<“Mid”<“H”) instead of a binary waveform of “L” and “H” conventionally used; the gate start pulse signal GSP has a ternary waveform of “L”, “Mid” and “H” (“L”<“Mid”<“H”) instead of the binary waveform of “L” and “H” conventionally used; and the gate bus line is step-charged (the voltage is raised step by step). The “H” portion (portion other than the “L” portion) of the conventional gate start pulse signal GSP and the “Mid” and “H” portions (portions other than the “L” portion) of the gate start pulse signal GSP according to an embodiment of the present invention correspond to the gate start pulse GSP.

“L”, “Mid” and “H” in the waveform of each of the gate clock signals GCK and “L”, “Mid” and “H” in the waveform of the gate start pulse signal GSP are independent from each other. The gate clock signals GCK and the gate start pulse signal GSP both rise from “L” to “Mid” to “H”, and fall, for example, from “H” to “L”. The gate clock signals GCK and the gate start pulse signal GSP may fall from “H” to “Mid” to “L”. However, it is preferred that the period of “Mid” is short during the fall. The voltage level of “Mid” during the fall may be different from the voltage level of “Mid” during the rise.

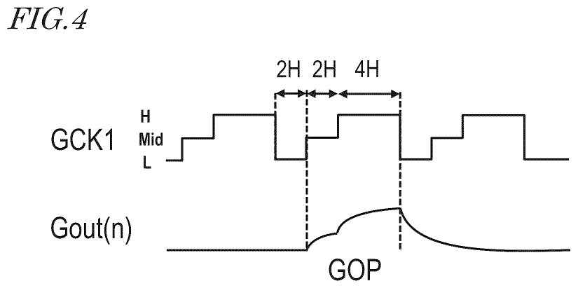

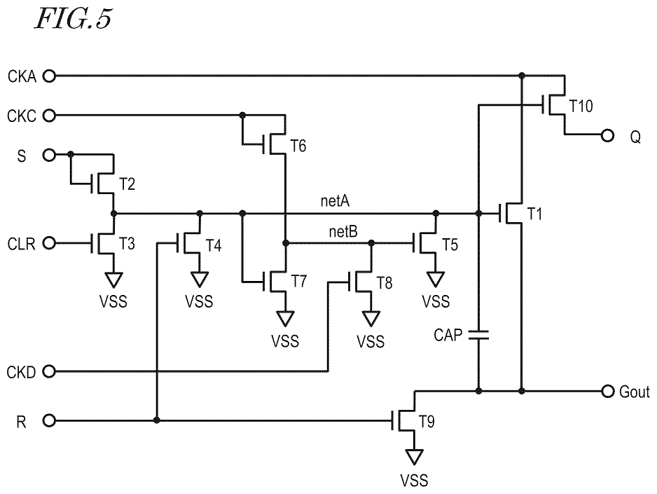

For example, as shown in FIG. 4, the waveform of each of the gate clock signals GCK is changed from “L”:“H”=2H:6H to “L”:“Mid”:“H”=2H:2H:4H. In this case, in the period of 6H of the “H” in the previous waveform, 2H is decreased to “Mid”. This makes it more difficult for the voltage of the gate-ON pulse GOP to reach the target level by the amount of the decrease, but the ease of the voltage of the gate-ON pulse GOP reaching the target level is improved than in the case of “L”:“H”=4H:4H. The periods of “L”, “Mid” and “H” are not limited to those described above, and it is sufficient that the periods fulfill the relationship of timing described below. In this example, the periods of “L”, “Mid” and “H” are each 1H total or longer.

The suppression on the shift of the TFT characteristic and the ease of the voltage of the gate-ON pulse reaching the target level are in a trade-off relationship. Therefore, as the voltage of “Mid” is closer to the voltage of “H”, the shift of the TFT characteristic is larger but the voltage of the gate-ON pulse reaches the target level more easily. By contrast, as the voltage of “Mid” is closer to the voltage of “L”, the shift of the TFT characteristic is smaller but the voltage of the gate-ON pulse reaches the target level less easily. It is desired that an actual liquid crystal display device is configured to allow the voltage of “Mid” to be set optionally such that an optimal voltage is set for “Mid”. For example, the voltage of “H” and the voltage of “L” are usually supplied from an external circuit. Therefore, the voltage of “Mid” may also be supplied from an external circuit, so that the voltage of the “Mid” is set optionally.

It may possibly raise the costs of the driving circuit to allow the gate clock signals GCK to have a ternary waveform. Therefore, it is proposed that a ternary waveform is applied to a liquid crystal display device driven at a high rate, whereas the gate clock signals in a usual liquid crystal display device each have a binary waveform. In this manner, the increase in the costs is kept minimum, and the liquid crystal panel is commonly usable to the two types of liquid crystal display devices.

FIG. 5 is a circuit diagram showing an example of configuration of a bistable circuit (flip-flop) included in a shift register of the gate driving circuit 120. As shown in FIG. 5, the bistable circuit includes ten thin film transistors T1 through T10 and a capacitor CAP. The bistable circuit further includes an input terminal for a low-level power supply voltage VSS, 6 input terminals S, CLR, CKA, R, CKC and CKD, and 2 output terminals Q and Gout. The terminal Q outputs a state signal Q, which is given to a bistable circuit on a stage different from the stage of the bistable circuit shown here, as a signal controlling an operation of the different-stage bistable circuit (hereinafter, the signal controlling the operation of the different-stage bistable circuit may be referred to as a “different stage control signal”). A signal from the output terminal Gout is output to a gate bus line corresponding to the bistable circuit.

A gate of the thin film transistor T1, a source of the thin film transistor T2, a drain of the thin film transistor T3, a drain of the thin film transistor T4, a drain of the thin film transistor T5, a gate of the thin film transistor T7 and a gate of the thin film transistor T10 are connected to each other. A region (lines) where these are connected to each other will be referred to as “netA” for the sake of convenience. A gate of the thin film transistor T5, a source of the thin film transistor T6, a drain of the thin film transistor T7 and a drain of the thin film transistor T8 are connected to each other. A region (lines) where these are connected to each other will be referred to as “netB” for the sake of convenience.

In the case where the waveform of each of the gate clock signals GCK is ternary and the duty ratio thereof is, for example, “L”:“Mid”:“H”=2H:2H:4H as described above so that the periods fulfill the relationship of timing described below, the maximum voltage of netA is decreased, for the following reason. When netA is bootstrapped from “L” to “Mid” and then is charged from “Mid” to “H”, the charge from “Mid” to “H” of netA is partially or entirely made ineffective. In the latter case, netA results in being merely charged from “L” to “Mid”, and the rise of the voltage of netA is suppressed more as compared with the case where netA is charged from “L” to “H” in the case of a binary waveform. Where the voltage drop of the diode-connected TFT is approximated to 0, the maximum voltage of netA is as follows:
in the case of the binary waveform: “H”+(“H”−“L”)
in the case of the ternary waveform: “Mid”+(“H”−“L”)

As can be seen, in the case where the waveform of each of the gate clock signals GCK is made ternary, the characteristic of a TFT having netA as the drain in the gate driving circuit 120 may possibly be improved, for the following reason. In general, in the case where an FET has a high source-drain voltage, breakdown occurs and a leakage current flows. Such breakdown may possibly occur in a TFT. From this point of view, it is preferred that the source-drain voltage is low.

Such an advantage of the ternary waveform that the leakage current caused by the breakdown is suppressed is provided regardless of the length of the period of the gate-ON pulse GOP (especially, the “H” period of the gate clock signals GCK). That is, the above-described advantage is provided by allowing the waveform to be ternary even in the case where there is no need to extend the period of the gate-ON pulse GOP (especially, the “H” period of the gate clock signals GCK).

Regarding the gate driving circuit 120, each of the TFTs driving the gate bus lines needs to be sufficiently turned on even when the drain thereof has a voltage of “H” so that the same level of “H” voltage is output from the source thereof. Therefore, the gate voltage (netA voltage) needs to be “‘H’ voltage+Vadd”. However, it is considered that Vadd does not need to be very high. Therefore, under the above-described simplified conditions, in the case of the binary waveform, Vadd=“H”−“L”. However, it may be considered that Vadd=“Mid”−“L” in the case of the ternary waveform with no problem.

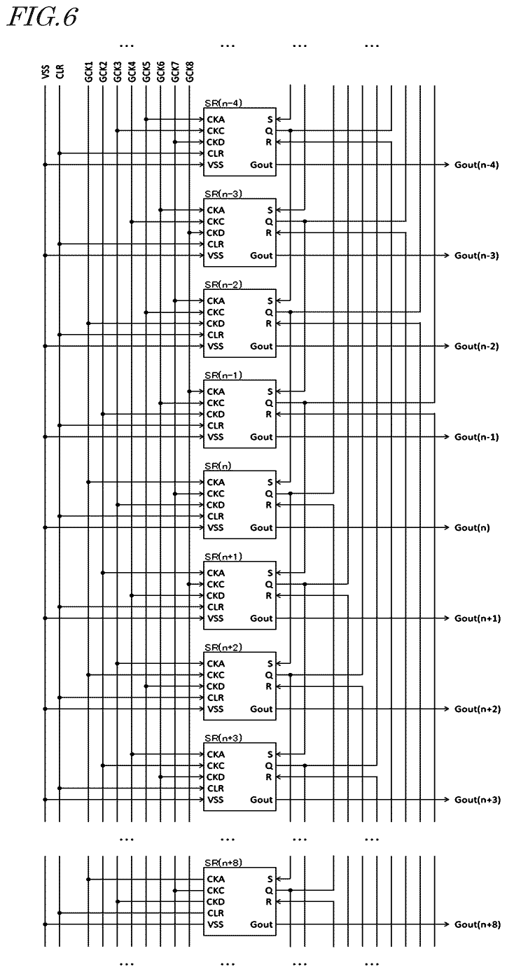

FIG. 6 is a block diagram of the shift register included in the gate driving circuit 120 in the liquid crystal display device 100 according to embodiment 1 of the present invention, and shows a central zone and the vicinity thereof of the display area. Eight (8-phase) gate clock signals GCK1 through 8 having different phases from each other are supplied from the control circuit 150. Herein, an nth pixel row is shown. Unit circuits SR of the shift register are each the bistable circuit (flip-flop) shown in FIG. 5. An input terminal S of an nth-stage unit circuit SR(n) is connected with an output terminal Q of an (n−2)th-stage unit terminal SR(n−2), and an input terminal R of the nth-stage unit circuit SR(n) is connected with an output terminal Q of an (n+8)th-stage unit terminal SR(n+8).

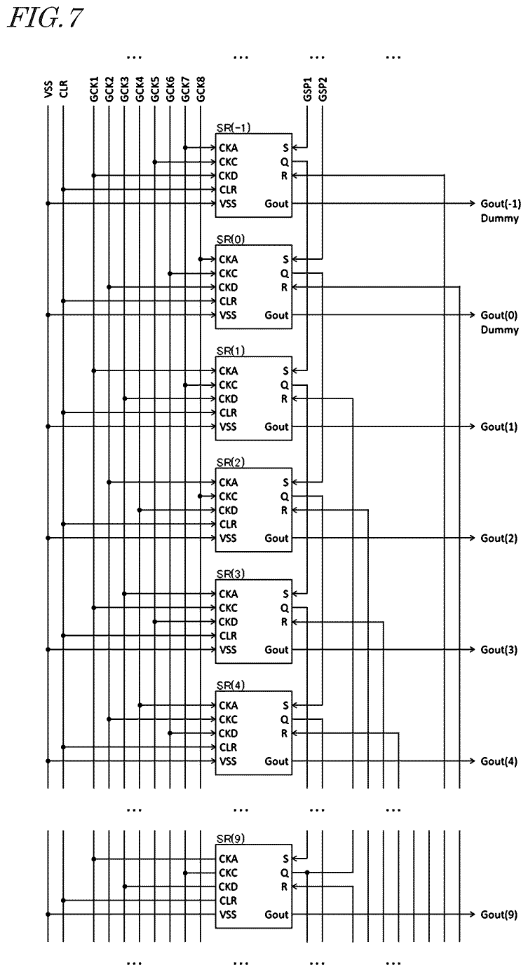

FIG. 7 is a block diagram of the shift register included in the gate driving circuit 120 in the liquid crystal display device 100 according to embodiment 1 of the present invention, and shows an uppermost zone of the display area. In FIG. 7, “(1)” represents correspondence with the first pixel row.

For generation of a signal to be input to the input terminal S of a first-stage unit circuit SR(1), a 0th-stage unit circuit SR(0) and a −1st-stage unit circuit SR(−1) are provided as dummy-stage unit circuits. GSP1 and GSP2 respectively input to input terminals S of the 0th-stage unit circuit SR(0) and the −1st-stage unit circuit SR(−1) are generated by the control circuit 150 outside the gate driving circuit 120. VSS, CLR and GCK1 through 8 are also generated by the control circuit 150.

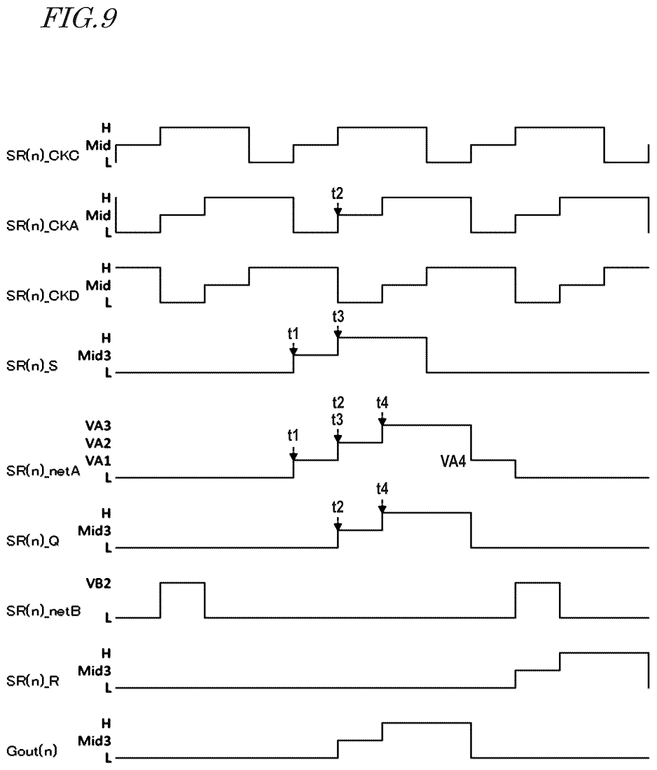

In the −1st-stage unit circuit SR(−1), GSP1 is input to the input terminal S, and GCK7 is input to an input terminal CKA. In this embodiment, as shown in FIG. 9, timing t1, at which GSP1 having a ternary waveform rises from “L” to “Mid”, timing t2, at which GCK7 having a ternary waveform rises from “L” to “Mid”, timing t2, and timing t3, at which GSP1 rises from “Mid” to “H” occur in this order. That is, t2 is between t1 and t3.

In the 0th-stage unit circuit SR(0), GSP2 is input to the input terminal S, and GCK8 is input to an input terminal CKA. In this embodiment, as shown in FIG. 9, timing t1, at which GSP2 having a ternary waveform rises from “L” to “Mid”, timing t2, at which GCK8 having a ternary waveform rises from “L” to “Mid”, and timing t3, at which GSP2 rises from “Mid” to “H” occur in this order. That is, t2 is between t1 and t3.

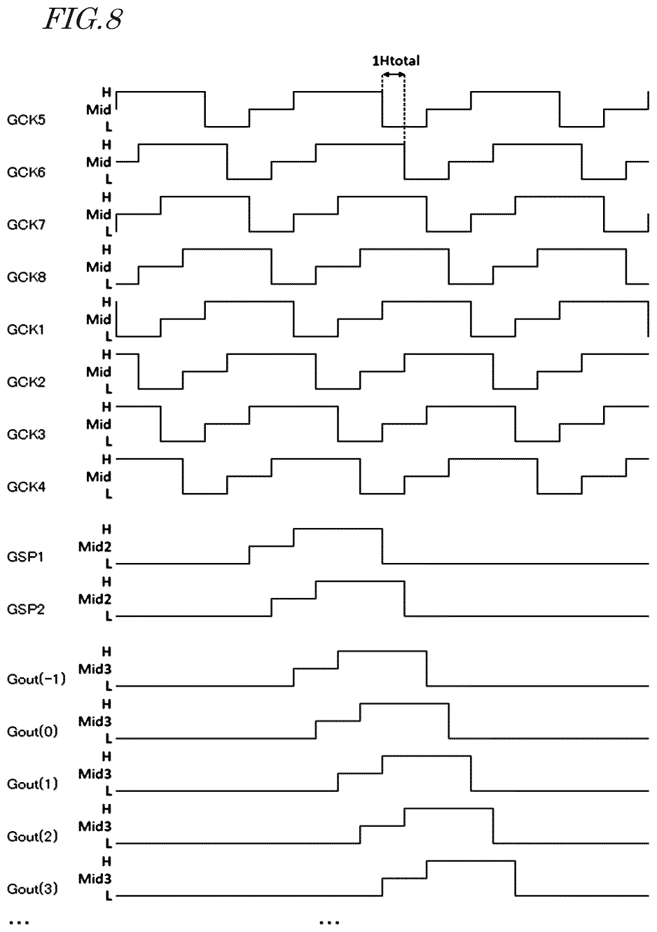

FIG. 8 is a timing diagram of signals in the liquid crystal display device 100 according to embodiment 1 of the present invention, and shows the uppermost zone of the display area. The waveforms are shown as including rectangular waves for the sake of ease of understanding, but in actuality, have shapes with obtuse angles as shown in FIG. 4 due to the ON-current characteristics of the TFTs in the display panel and the parasitic loads (resistances, capacitances, etc.) of the TFTs and the lines.

As shown in FIG. 8, the gate clock signals GCK1 through 8 each have voltages of three levels of “L”, “Mid” and “H”. The gate start pulse signals GSP1 and GSP2 each have voltages of three levels of “L”, “Mid2” and “H”. Basically, it may be considered that “Mid2”=“Mid” with no problem. It may also be considered that “Mid2” #“Mid”. The phase difference of each of the gate clock signals GCK1 through 8 is 1H total. In the following, “Mid2” “Mid” for the sake of simplicity of description.

The waveform of each of the gate clock signals GCK1 through 8 has a duty ratio of “L”:“Mid”:“H”=2H:2H:4H. The waveform of each of the gate start pulse signals GSP1 and GSP2 has a duty ratio of “Mid”:“H”=2H: 4H, with the remaining period being “L”. As a result, the waveform of Gout(n) also has a duty ratio of “Mid”:“H”=2H:4H, with the remaining period being “L”.

In FIG. 8, the waveforms are shown with a unit of 1H total. The timing of the transfer from “L” to “Mid” and the timing of the transfer from “Mid” to “H” of every other gate clock signals among the gate clock signals GCK1 through 8 (for example, the timing of the transfer from “L” to “Mid” of GCK1 and the timing of the transfer from “Mid” to “H” of GCK7) are shown to occur at the same time. However, in actuality, the latter is often delayed. That is, more precisely, the gate clock signals GCK1 through 8 often have a duty ratio of, for example, “L”:“Mid”:“H”=2H: 2.1H:3.9H. The values of decimal numbers less than 1H are also controlled in this manner, so that t3 occurs after t2 with certainty.

One cycle of each of the gate clock signals GCK1 through 8 is 8H, and the period of “Mid” in one cycle of each of the gate clock signals GCK1 through 8 is 2H (or 2.1H), which is equal to, or longer than, ¼ of one cycle of each of the gate clock signals GCK1 through 8 (one cycle of each of the gate clock signals GCK1 through 8 is 8H, and ¼ thereof is 2H). The period of “Mid” in one cycle (e.g., one vertical scanning period) of each of the gate start pulse signals GSP1 and GSP2 is 2H (or 2.1H), which is equal to, or longer, than ¼ of one cycle of each of the gate clock signals GCK1 through 8 (one cycle of each of the gate clock signals GCK1 through 8 is 8H, and ¼ thereof is 2H). The period of “Mid” in one cycle of each of the gate start pulse signals GSP1 and GSP2 may be slightly shorter than ¼ of one cycle of each of the gate clock signals GCK1 through 8 (one cycle of each of the gate clock signals GCK1 through 8 is 8H, and ¼ thereof is 2H; and the period of “Mid” in one cycle of each of the gate start pulse signals GSP1 and GSP2 may be shorter than 2H by, for example, less than 1H).

The period of “H” in one cycle of each of the gate clock signals GCK1 through 8 is 4H (or 3.9H), which is equal to, or shorter than, ½ of one cycle of each of the gate clock signals GCK1 through 8 (one cycle of each of the gate clock signals GCK1 through 8 is 8H, and ½ thereof is 4H). The period of “H” in one cycle (e.g., one vertical scanning period) of each of the gate start pulse signals GSP1 and GSP2 is 4H (or 3.9H), which is equal to, or shorter than, ½ of one cycle of each of the gate clock signals GCK1 through 8 (one cycle of each of the gate clock signals GCK1 through 8 is 8H, and ½ thereof is 4H). The period of “H” in one cycle of each of the gate start pulse signals GSP1 and GSP2 may be slightly longer than ½ of one cycle of each of the gate clock signals GCK1 through 8 (one cycle of each of the gate clock signals GCK1 through 8 is 8H, and ½ thereof is 4H; and the period of “H” in one cycle of each of the gate start pulse signals GSP1 and GSP2 may be longer than 4H by, for example, less than 1H).

VSS is a power supply signal and has a simple DC waveform, and therefore, is not shown. CLR is a clear signal and generates a “H” pulse in a non-effective scanning period (NE), but is not specifically related to the present invention and thus is not shown.

FIG. 9 is a timing diagram of signals in the liquid crystal display device 100 according to embodiment 1 of the present invention, and shows waveforms in the shift register. The shift register included in the gate driving circuit 120 in the liquid crystal display device 100 according to embodiment 1 operates, for example, as follows.

Hereinafter, input/output terminals SR(n)_Q, SR(n)_S, SR(n)_R, SR(n)_CKA, SR(n)_CKC, SR(n)_CKD, SR(n)_netA and SR(n)_netB of each of stages of the shift register will be represented simply as Q, S, R, CKA, CKC, CKD, netA and netB for the sake of simplicity. As shown in FIG. 9, the signals at Q, S and R are each represented by voltages of three levels of “L”, “Mid3” and “H”. The signal at netA is represented by voltages of “L”, VA1, VA2, VA3 and VA4, and the signals at netB is represented by voltages of “L” and VB2. Regarding all the above signals, the “L” voltage is the same as the VSS voltage. The “L” voltage (VSS voltage) is usually set to be negative with respect to the GND (0 V), for example, is set to −6 V. In the following, “Mid3≈Mid” for the sake of simplicity description.

(Operation Regarding netA)

First, at t1, when the voltage of the input terminal S (may be referred to as an “S voltage”) is transferred from “L” to “Mid”, T2 is turned on to raise the voltage of netA to the VA1 voltage. T2 is a so-called diode-connected transistor, and thus, the drain voltage is slightly dropped with respect to the source voltage. Therefore, the VA1 voltage is slightly dropped with respect to the “Mid” voltage.

Next, at t2, the voltage of the input terminal CKA (may be referred to as a “CKA voltage”) is transferred from “L” to “Mid”. Soon thereafter, at t3, the S voltage is transferred from “Mid” to “H”. In FIG. 9, t2 and t3 are shown to occur at the same time, but in actuality, a slight time delay is provided as described above with reference to FIG. 8. That is, first, at t2, the netA voltage is raised by the bootstrap by T1 and CAP as a result of the transfer of the CKA voltage. In other words, VA2a=VA1+(“Mid”−“L”)*β(* represents multiplication).

β is as follows, and is, for example, β=0.8 or the like.

$$β = CAP / ( CA + CAP )$$

CAP is the CAP capacitance in FIG. 5.

CA represents the parasitic capacitance of netA other than CAP.

Then, at t3, when the S voltage becomes “H”, the netA voltage becomes the VA2 voltage. VA2 is as follows.

In the case where VA2a>H−α, VA2=VA2a

In the case where VA2a≤H−α, VA2=“H”−α

(α is the voltage drop of the diode-connected transistor T2.)

The former (VA2=VA2a) is a typical case. Hereinafter, this case will be described.

Next, at t4, the CKA voltage is transferred from “Mid” to “H”. The netA voltage is raised by the bootstrap by T1 and CAP as a result of the transfer of the CKA voltage.

$$VA 3 = VA 2 + ( “ H ” - “ Mid ” ) * β = VA 1 + ( “ Mid ” - “ L ” ) * β + ( “ H ” - “ Mid ” ) * β = “ Mid ” - α + ( “ H ” - “ L ” ) * β$$

Now, approximation of β≈1 and α≈0 results in the following:

$$VA 3 = “ Mid ” + ( “ H ” - “ L ” )$$

In the case where the GCK1 through 8 voltages each have a conventional binary waveform, substantially the same approximation calculation results in the netA voltage being “H”+(“H”−“L”). By contrast, in embodiment 1 of the present invention, the maximum level of the netA voltage is lower than the voltage in the conventional case by about (“H”−“Mid”).

Next, when the CKA voltage is transferred from “H” to “L”, the netA voltage is drastically dropped by CAP.

$$VA 4 = VA 3 - ( “ H ” - “ L ” ) * β$$

In a final process, when the R voltage is transferred from “L” to “Mid”, T4 is turned on to drop the netA voltage to the VSS voltage.

The following operation is performed except for during the scanning pass of the GOA shift register in order to avoid malfunction that would otherwise be caused by noise or the like.
When the netB voltage becomes the VB2 voltage, T5 is turned on to drop the netA voltage to the VSS voltage.
The CLR voltage is raised during a certain period in the non-effective scanning period (NE) to turn on T3 and thus to drop the netA voltage to the VSS voltage.
   (Operation Regarding netB)

The TFT size of T8 is made larger than that of T6 so that when T6 and T8 are turned on at the same time, T8 is prioritized. In the case where the netA voltage is other than the “L” voltage (VA1, VA2, VA3 or VA4), T7 is turned on. Therefore, the netB voltage is driven to the “L” voltage.

The TFT size of T8 is made larger than that of T7 so that when T7 and T8 are turned on at the same time, TB is prioritized.

As a result of the above-described operations, the netB voltage is raised to the VB2 voltage only when the CKC voltage is “H”, the CKD voltage is “L” and the netA voltage is “L”. VB2=“H”−α.

### (Operation Regarding Q)

In the case where netA has a voltage other than “L” (VA1, VA2, VA3 or VA4), T10 is turned on and the Q voltage becomes the CKA voltage. That is, the Q voltage is changed from “L” to “Mid” to “H” to “L”. When the netA voltage is the VA4 voltage, the Q voltage is changed from “H” to “L”.

### (Operation Regarding Gout)

The operation regarding Gout is basically substantially the same as that regarding Q. Gout has a large load (resistance+capacitance) in the gate bus line of the active area of the display panel. Therefore, the TFT size of T1 is made larger than that of T10. T9 is turned on when the R voltage is transferred from “Mid” or “L”, so that the transfer of Gout from “H” to “L” is made with certainty.

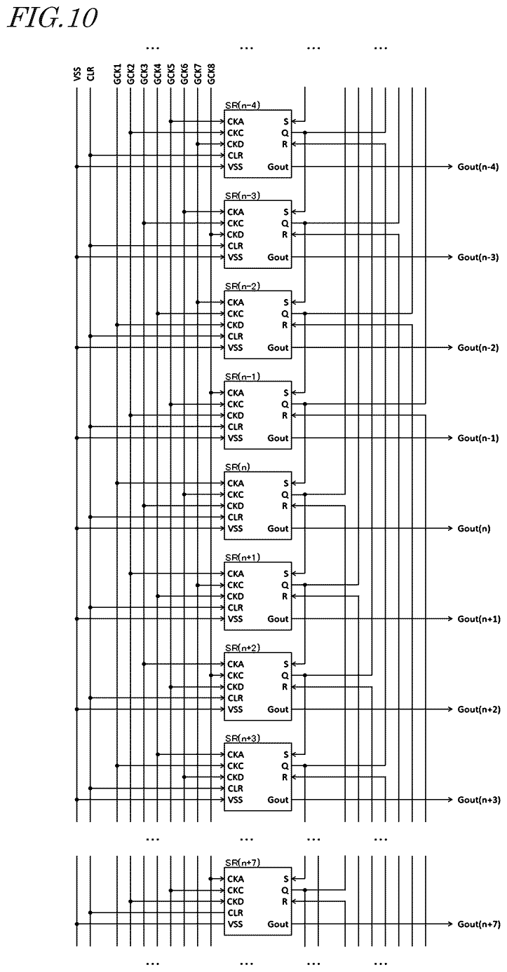

Now, with reference to FIG. 10 through FIG. 13, an operation of the liquid crystal display device 100 according to embodiment 2 of the present invention will be described. An overall configuration of the liquid crystal display device 100 according to embodiment 2 is the same as that of the liquid crystal display device 100 according to embodiment 1.

FIG. 10 is a block diagram of the shift register included in the gate driving circuit 120 in the liquid crystal display device 100 according to embodiment 2 of the present invention, and shows a central zone and the vicinity thereof of the display area. Eight (8-phase) gate clock signals GCK1 through 8 having different phases from each other are supplied from the control circuit 150. Herein, an nth pixel row is shown. Unit circuits SR of the shift register are each the bistable circuit (flip-flop) shown in FIG. 5. An input terminal S of an nth-stage unit circuit SR(n) is connected with an output terminal Q of an (n−1)th-stage unit terminal SR(n−1), and an input terminal R of the nth-stage unit circuit SR(n) is connected with an output terminal Q of an (n+7)th-stage unit terminal SR(n+7).

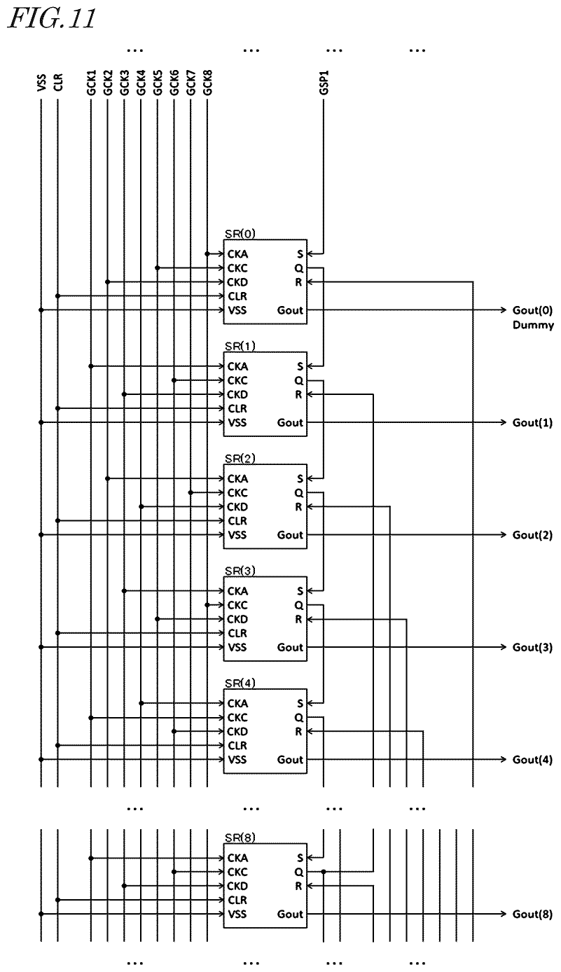

FIG. 11 is a block diagram of the shift register included in the gate driving circuit 120 in the liquid crystal display device 100 according to embodiment 2 of the present invention, and shows an uppermost zone of the display area. In FIG. 11, “(1)” represents correspondence with the first pixel row.

For generation of a signal to be input to the input terminal S of a first-stage unit circuit SR(1), a 0th-stage unit circuit SR(0) is provided as a dummy-stage unit circuit. GSP1 input to an input terminal S of the 0th-stage unit circuit SR(0) is generated by the control circuit 150 outside the gate driving circuit 120. VSS, CLR and GCK1 through 8 are also generated by the control circuit 150.

In the 0th-stage unit circuit SR(0), GSP1 is input to the input terminal S, and GCK8 is input to an input terminal CKA. In this embodiment, as shown in FIG. 13, timing t1, at which GSP1 having a ternary waveform rises from “L” to “Mid”, timing t2, at which GCK8 having a ternary waveform rises from “L” to “Mid”, and timing t3, at which GSP1 rises from “Mid” to “H” occur in this order. That is, t2 is between t1 and t3.

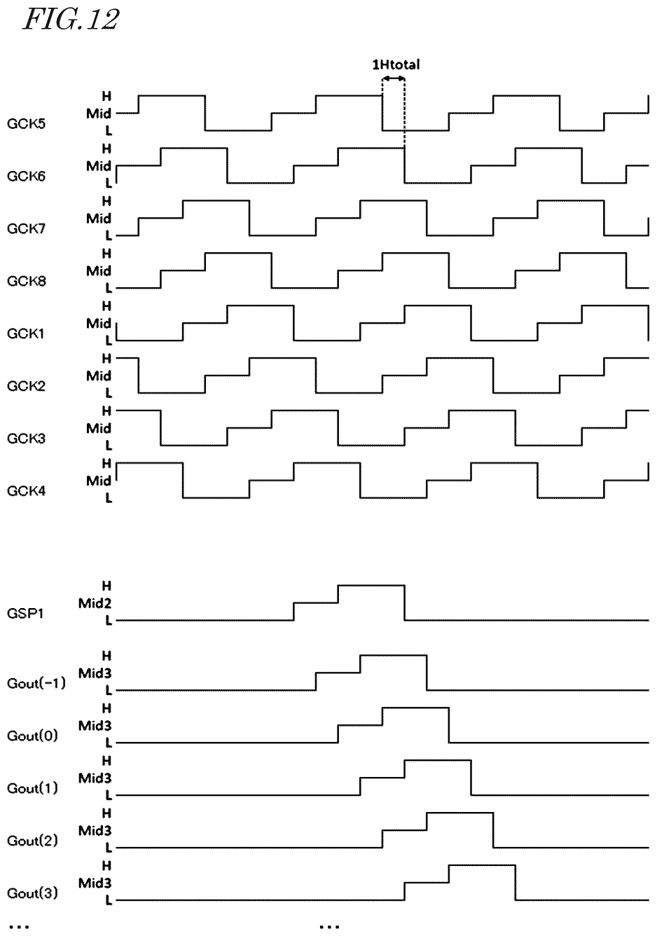

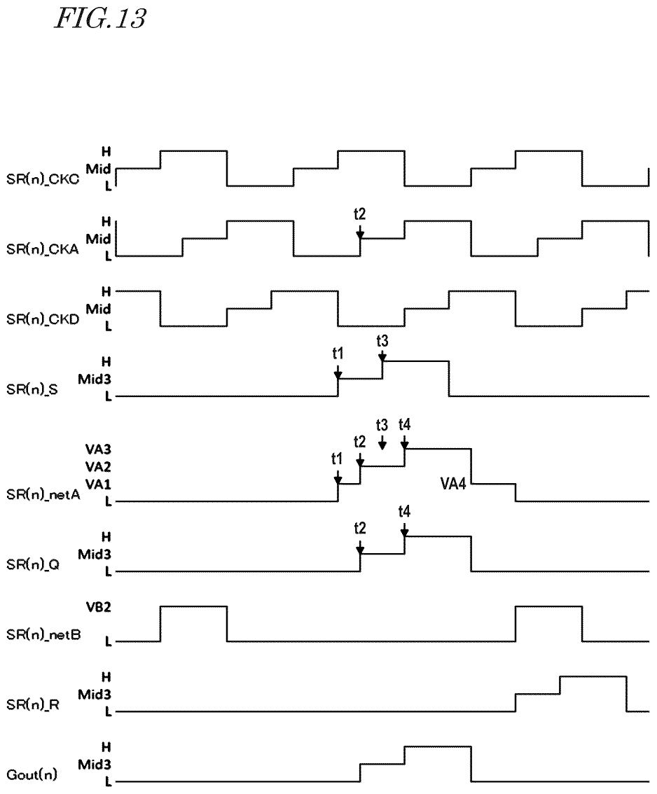

FIG. 12 is a timing diagram of signals in the liquid crystal display device 100 according to embodiment 2 of the present invention, and shows the uppermost zone of the display area. The waveforms are shown as including rectangular waves for the sake of ease of understanding, but in actuality, have shapes with obtuse angles as shown in FIG. 4 due to the ON-current characteristics of the TFTs in the display panel and the parasitic loads (resistances, capacitances, etc.) of the TFTs and the lines.

As shown in FIG. 12, the gate clock signals GCK1 through 8 each have voltages of three levels of “L”, “Mid” and “H”. The gate start pulse signal GSP1 has voltages of three levels of “L”, “Mid2” and “H”. Basically, it may be considered that “Mid2”=“Mid” with no problem. It may also be considered that “Mid2” #“Mid”. The phase difference of each of the gate clock signals GCK1 through 8 is 1H total. In the following, “Mid2”≈“Mid” for the sake of simplicity of description.

The waveform of each of the gate clock signals GCK1 through 8 has a duty ratio of “L”:“Mid”:“H”=3H:2H:3H. The waveform of the gate start pulse signal GSP1 has a duty ratio of “Mid”:“H”=2H:3H, with the remaining period being “L”. As a result, the waveform of Gout(n) also has a duty ratio of “Mid”:“H”=2H:3H, with the remaining period being “L”.

One cycle of each of the gate clock signals GCK1 through 8 is 8H, the period of “Mid” in one cycle of each of the gate clock signals GCK1 through 8 is 2H, which is equal to, or longer than, ¼ of one cycle of each of the gate clock signals GCK1 through 8 (one cycle of each of the gate clock signals GCK1 through 8 is 8H, and ¼ thereof is 2H). The period of “Mid” in one cycle (e.g., one vertical scanning period) of the gate start pulse signal GSP1 is 2H, which is equal to, or longer than, ¼ of one cycle of each of the gate clock signals GCK1 through 8 (one cycle of each of the gate clock signals GCK1 through 8 is 8H, and ¼ thereof is 2H). The period of “Mid” in one cycle of the gate start pulse signal GSP1 may be slightly shorter than ¼ of one cycle of each of the gate clock signals GCK1 through 8 (one cycle of each of the gate clock signals GCK1 through 8 is 8H, and ¼ thereof is 2H; and the period of “Mid” in one cycle of the gate start pulse signal GSP1 may be shorter than 2H by, for example, less than 1H).

The period of “H” in one cycle of each of the gate clock signals GCK1 through 8 is 3H, which is equal to, or shorter than, ½ of one cycle of each of the gate clock signals GCK1 through 8 (one cycle of each of the gate clock signals GCK1 through 8 is 8H, and ½ thereof is 4H). The period of “H” in one cycle (e.g., one vertical scanning period) of the gate start pulse signal GSP1 is 3H, which is equal to, or shorter than, ½ of one cycle of each of the gate clock signals GCK1 through 8 (one cycle of each of the gate clock signals GCK1 through 8 is 8H, and ½ thereof is 4H). The period of “H” in one cycle of the gate start pulse signal GSP1 may be slightly longer than ½ of one cycle of each of the gate clock signals GCK1 through 8 (one cycle of each of the gate clock signals GCK1 through 8 is 8H, and ½ thereof is 4H; and the period of “H” in one cycle of the gate start pulse signal GSP1 may be longer than 4H by, for example, less than 1H).

In FIG. 12, the waveforms are shown with a unit of 1H total. The timing of the transfer from “L” to “Mid” and the timing of the transfer from “Mid” to “H” of every other gate clock signals among the gate clock signals GCK1 through 8 (for example, the timing of the transfer from “L” to “Mid” of GCK1 and the timing of the transfer from “Mid” to “H” of GCK7) are shown to occur at the same time. In embodiment 2, unlike in embodiment 1, the timing of the transfer from “L” to “Mid” and the timing of the transfer from “Mid” to “H” of every other gate clock signals among the gate clock signals GCK1 through 8 may occur at the same time in actuality. In embodiment 1, the timings do not occur at the same time, and an arrangement to slightly delay, for example, the latter is required. There is an undesirable possibility that the effect of the arrangement is not sufficiently provided due to the variance in the production of the display panels and the like. In embodiment 2, such an arrangement is not necessary, and a stable operation is considered to be provided regardless of the variance in the production of the display panels.

VSS is a power supply signal and has a simple DC waveform, and therefore, is not shown. CLR is a clear signal and generates a “H” pulse in a non-effective scanning period (NE), but is not specifically related to the present invention and thus is not shown.

FIG. 13 is a timing diagram of signals in the liquid crystal display device 100 according to embodiment 2 of the present invention, and shows waveforms in the shift register. The shift register included in the gate driving circuit 120 in the liquid crystal display device 100 according to embodiment 2 operates, for example, as follows.

Hereinafter, input/output terminals SR(n)_Q, SR(n)_S, SR(n)_R, SR(n)_CKA, SR(n)_CKC, SR(n)_CKD, SR(n)_netA and SR(n)_netB of each of stages of the shift register will be represented simply as Q, S, R, CKA, CKC, CKD, netA and netB for the sake of simplicity. As shown in FIG. 13, the signals at Q, S and R are each represented by voltages of three levels of “L”, “Mid3” and “H”. The signal at netA is represented by voltages of “L”, VA1, VA2, VA3 and VA4, and the signal at netB is represented by voltages of “L” and VB2. Regarding all the above signals, the “L” voltage is the same as the VSS voltage. The “L” voltage (VSS voltage) is usually set to be negative with respect to the GND (0 V), for example, is set to −6 V. In the following, “Mid3≈Mid” for the sake of simplicity of description.

(Operation Regarding netA)

First, at t1, when the voltage of the input terminal S (may be referred to as an “S voltage”) is transferred from “L” to “Mid”, T2 is turned on to raise the voltage of netA to the VA1 voltage. T2 is a so-called diode-connected transistor, and thus, the drain voltage is slightly dropped with respect to the source voltage. Therefore, the VA1 voltage is slightly dropped with respect to the “Mid” voltage. VA1=“Mid”−α (α is the voltage drop of the diode-connected transistor T2.)

Next, at t2, the voltage of the input terminal CKA (may be referred to as a “CKA voltage”) is transferred from “L” to “Mid”. Also at t2, the netA voltage is raised to the VA2a voltage by the bootstrap by T1 and CAP as a result of the transfer of the CKA voltage. That is, VA2a=VA1+(“Mid”−“L”)*β.

β is as follows, and is, for example, β=0.8 or the like.

$$β = CAP / ( CA + CAP )$$

CAP is the CAP capacitance in FIG. 5.

CA represents the parasitic capacitance of netA other than CAP.

Then, at t3, when the S voltage becomes “H”, the netA voltage becomes the VA2 voltage. VA2 is as follows.

In the case where VA2a>H−α, VA2=VA2a

In the case where VA2a≤H−α, VA2=“H”−α

(α is the voltage drop of the diode-connected transistor T2.)

The former (VA2=VA2a) is a typical case. Hereinafter, this case will be described.

FIG. 13 shows the former case, that is, the case of VA2=VA2a. Therefore, the netA voltage is not changed at timing t3.

Next, at t4, the CKA voltage is transferred from “Mid” to “H”. The netA voltage is raised by the bootstrap by T1 and CAP as a result of the transfer of the CKA voltage.

$$VA 3 = VA 2 + ( “ H ” - “ Mid ” ) * β = VA 1 + ( “ Mid ” - “ L ” ) * β + ( “ H ” - “ Mid ” ) * β = “ Mid ” - α + ( “ H ” - “ L ” ) * β$$

Now, approximation of β≈1 and α≈0 results in the following:

$$VA 3 = “ Mid ” + ( “ H ” - “ L ” )$$

In the case where the GCK1 through 8 voltages each have a conventional binary waveform, substantially the same approximation calculation results in the netA voltage being “H”+(“H”−“L”). By contrast, in embodiment 2 of the present invention, the maximum level of the netA voltage is lower than the voltage in the conventional case by about (“H”−“Mid”), like in embodiment 1.

Next, when the CKA voltage is transferred from “H” to “L”, the netA voltage is drastically dropped by CAP.

$$VA 4 = VA 3 - ( “ H ” - “ L ” ) * β$$

In a final process, when the R voltage is transferred from “L” to “Mid”, T4 is turned on to drop and the netA voltage to the VSS voltage.

The following operation is performed except for during the scanning pass of the GOA shift register in order to avoid malfunction that would otherwise be caused by noise or the like.
When the netB voltage becomes the VB2 voltage, T5 is turned on to drop the netA voltage to the VSS voltage.
The CLR voltage is raised during a certain period in the non-effective scanning period (NE) to turn on T3 and thus to drop the netA voltage to the VSS voltage.

The operation regarding netB, the operation regarding Q and the operation regarding Gout may be the same as those described above in embodiment 1, and will not be described.

As described above, in the liquid crystal display device according to an embodiment of the present invention, the “Mid” level is introduced into the gate clock to prevent the “H” duty time of the gate clock from being extended. In this manner, the shift of the threshold value of the TFT is suppressed, and the maximum level of the netA voltage is suppressed to be lower than in the conventional liquid crystal display device. Therefore, the malfunction of the TFT having netA as the drain, caused by a leakage current due to breakdown, is suppressed. In addition, the problem is suppressed that the voltage of the gate-ON pulse of the gate scanning signal does not reach the target level in the case where a large-scale, high-definition liquid crystal display device is driven at a high rate.

In the above-described examples, the gate clock signals are 8-phase signals. For example, the duty ratio of the ternary waveform in embodiment 1 may be “L”: “Mid”:“H”=1H:1H:2H. In this case, substantially the same effect is provided with 4-phase signals.

It is sufficient that the level of “Mid” is between “L” and “H”, and is not limited to a middle level between “L” and “H”. Note that in the case where the level of “Mid” is close to “H” or close to “L”, the effect of the ternary waveform may not sufficiently be provided undesirably. Therefore, it is preferred that, for example, the “VA3−L” level is lower than the source-drain breakdown voltage of the TFT. Specific expressions for this will be provided. In the case where the “VA3−‘L’” level is close to the “H” level, it is preferred that the “‘Mid’−α+(‘H’−‘L’)*β−‘L’” level is lower than the source-drain breakdown voltage of the TFT. In the case where the “VA3−L” level is close to the “L” level, it is preferred that the “‘H’−‘L’−α+(‘H’−‘Mid’)*β” level is lower than the source-drain breakdown voltage of the TFT. It is more preferred that the “Mid” level is lower than the voltage at which the shift of the TFT characteristic becomes conspicuous.

The display device according to embodiments of the present invention is widely usable for, for example, large-scale and/or high-definition liquid crystal display devices.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. A display device, comprising:
a plurality of pixels arrayed in a matrix including a plurality of pixel rows and a plurality of pixel columns;
a plurality of scanning signal lines each associated with any of the plurality of pixel rows;
a plurality of display signal lines each associated with any of the plurality of pixel columns;
a scanning signal line driving circuit supplying the plurality of scanning signal lines with scanning signals each including a selection pulse selecting any of the plurality of pixel rows;
a display signal line driving circuit supplying the plurality of display signal lines with display signals; and
a control circuit supplying the scanning signal line driving circuit and the display signal line driving circuit with control signals,
wherein the control circuit is configured to supply the scanning signal line driving circuit with k-phase gate clock signals (k is an integer of 4 or greater) having different phases from each other and gate start pulse signals,
wherein the scanning signal line driving circuit includes a shift register circuit including a plurality of unit circuits,
wherein each of the gate clock signals respectively input to the plurality of unit circuits has voltages of three levels of “L”, “Mid” and “H” (“L”<“Mid”<“H”), and rises in the order of “L” to “Mid” to “H”,
wherein each of the gate start pulse signals respectively input to the plurality of unit circuits has voltages of three levels of “L”, “Mid” and “H” (“L”<“Mid”<“H”), and rises in the order of “L” to “Mid” to “H”, and
wherein the timing at which the gate clock signals rise from “L” to “Mid” is between the timing at which the gate start pulse signals rise from “L” to “Mid” and the timing at which the gate start pulse signals rise from “Mid” to “H”.

2. The display device of claim 1, wherein a period of “Mid” in one cycle of each of the gate clock signals is ¼ of one cycle of each of the gate clock signals or longer.

3. The display device of claim 2, wherein a period of “Mid” in one cycle of each of the gate start pulse signals is ¼ of one cycle of each of the gate clock signals or longer.

4. The display device of claim 1, wherein a period of “H” in one cycle of each of the gate clock signals is ½ of one cycle of each of the gate clock signals or shorter.

5. The display device of claim 3, wherein a period of “H” in one cycle of each of the gate start pulse signals is ½ of one cycle of each of the gate clock signals or shorter.
